(19) United States
(12) Patent Application Publication
(10) Pub. No.: US 2026/0257928 A1
(43) Pub. Date: Sep. 3, 2026

(54) METHODS OF PREPARING MESOPOROUS NANO ZEOLITE

(71) Applicant: Saudi Arabian Oil Company, Dhahran (SA)

(72) Inventors: Mohammed Z. Albahar, Dhahran (SA); Lianhui Ding, Dhahran (SA); Batool Altaher, Dhahran (SA); Faisal M. Almulla, Dhahran (SA)

(21) Appl. No.: 19/068,637

(22) Filed: Mar. 3, 2025

(51) Int. Cl. C01B 39/48; B01J 29/70; B01J 35/45; B01J 35/63; B01J 35/64; B01J 37/00; B01J 37/04; B01J 37/06; B01J 37/08; C01B 39/02

(52) U.S. Cl. CPC C01B 39/48; B01J 29/7007; B01J 35/45; B01J 35/635; B01J 35/638; B01J 35/647; B01J 37/0018; B01J 37/0036; B01J 37/04; B01J 37/06; B01J 37/082; C01B 39/026; C01P 2004/64; C01P 2006/14; C01P 2006/16

(57) ABSTRACT

This disclosure relates to methods of preparing mesoporous nano zeolite including a one pot dry gel conversion of zeolite precursor materials to mesoporous nano zeolite.

### TECHNICAL FIELD

This document relates to methods of preparing mesoporous nano zeolite including a one pot dry gel conversion of zeolite precursor materials to mesoporous nano zeolite.

### BACKGROUND

Zeolites, such as mesoporous nano zeolite, are widely used in petroleum processing for various applications, such as catalytic cracking, catalytic reforming, and hydrocracking. The efficiency of a zeolite catalyst is often hindered by the diffusion limitations of molecules through the pore structures, where smaller pores limit the diffusion of larger hydrocarbon molecules. Therefore, synthetic methods resulting in zeolites with high mesoporosity are needed.

Mesoporous zeolites are zeolites with an average pore diameter of between about 2 and about 50 nm. Zeolites with larger pore sizes are able to adsorb larger molecules than those with smaller pore sizes. Typically, mesoporous zeolites are prepared in two steps. First, by preparing a dry gel zeolite. Second, post-synthesis modifications are performed on the dry gel zeolite to form mesoporous zeolite. The utilization of multiple synthetic steps to prepare zeolites requires longer synthetic times, more starting materials, higher energy costs, and, often, lower yields of products.

Thus, the development of more efficient synthetic methods to produce mesoporous zeolites with larger pore volumes is desirable.

### SUMMARY

The disclosure relates to methods of preparing a mesoporous nano zeolite comprising: combining zeolite precursor materials, wherein the zeolite precursor materials comprise an aluminum source, a silica source, a template source, and a surfactant; stirring the zeolite precursor materials in the same reaction vessel to form a zeolite precursor mixture; drying the zeolite precursor mixture to form a dried zeolite powder; heating the dried zeolite powder in an autoclave to form a crystallized zeolite; and calcinating the crystallized zeolite to form a mesoporous nano zeolite.

In some embodiments, the method further comprises grinding the dried zeolite powder.

In some embodiments, the method further comprises washing the crystallized zeolite with a solvent.

In some embodiments, the method further comprises drying the crystallized zeolite after washing the crystallized zeolite.

In some embodiments, the aluminum source is selected from NaAlO₂, aluminum isopropoxide (AIP), Al₂(SO₄)₃, Al(NO₃)₃, AlCl₃, metal aluminum, and Al₂O₃.

In some embodiments, the silica source is selected from tetraethylorthosilicate (TEOS), colloidal silica, Na₂SiO₃, and fumed silica.

In some embodiments, the template source is selected from tetrapropylammonium hydroxide (TPAOH) and tetraethylammonium hydroxide (TEAOH).

In some embodiments, the surfactant is selected from cetyltrimethylammonium bromide (CTAB) and cetrimonium chloride (CTAC).

In some embodiments, the aluminum source is selected from NaAlO₂, aluminum isopropoxide (AIP), Al₂(SO₄)₃, Al(NO₃)₃, AlCl₃, metal aluminum, and Al₂O₃; the silica source is selected from tetraethylorthosilicate (TEOS), colloidal silica, Na₂SiO₃, and fumed silica; the template source is selected from tetrapropylammonium hydroxide (TPAOH) and tetraethylammonium hydroxide (TEAOH); and the surfactant is selected from cetyltrimethylammonium bromide (CTAB) and cetrimonium chloride (CTAC).

In some embodiments, the aluminum source is NaAlO₂; the silica source is fumed silica; the template source is tetraethylammonium hydroxide (TEAOH); and the surfactant is cetyltrimethylammonium bromide (CTAB).

In some embodiments, the mesoporous nano zeolite is mesoporous nano beta zeolite.

In some embodiments, the mesoporous nano zeolite has an average particle size of about 45 nm to about 55 nm.

In some embodiments, the mesoporous nano zeolite is formed in a yield of about 90% to about 100%.

In some embodiments, the mesoporous nano zeolite has an average pore volume of about 1.0 mL/g to about 1.8 mL/g.

In some embodiments, the mesoporous nano zeolite has an average pore volume of about 1.1 mL/g to about 1.7 mL/g.

In some embodiments, the mesoporous nano zeolite has an average pore size of about 7.8 nm to about 8.8 nm.

In some embodiments, the mesoporous nano zeolite has a relative crystallinity of about 90% to about 100%.

The disclosure further relates to methods of preparing a mesoporous nano zeolite comprising: combining zeolite precursor materials in a reaction vessel, wherein the zeolite precursor materials comprise an aluminum source, a silica source, a template source, and a surfactant; stirring the zeolite precursor materials in the same reaction vessel to form a zeolite precursor mixture; drying the zeolite precursor mixture to form a dried zeolite powder; grinding the dried zeolite powder; heating the dried zeolite powder in an autoclave to form a crystallized zeolite; washing the crystallized zeolite with a solvent; drying the crystallized zeolite; and calcinating the crystallized zeolite to form a mesoporous nano zeolite.

In some embodiments, the aluminum source is selected from NaAlO₂, aluminum isopropoxide (AIP), Al₂(SO₄)₃, Al(NO₃)₃, AlCl₃, metal aluminum, and Al₂O₃; the silica source is selected from tetraethylorthosilicate (TEOS), colloidal silica, Na₂SiO₃, and fumed silica; the template source is selected from tetrapropylammonium hydroxide (TPAOH) and tetraethylammonium hydroxide (TEAOH); and the surfactant is selected from cetyltrimethylammonium bromide (CTAB) and cetrimonium chloride (CTAC).

In some embodiments, the mesoporous nano zeolite has an average pore volume of about 1.1 mL/g to about 1.7 mL/g.

### DETAILED DESCRIPTION

The present disclosure relates to methods of preparing a mesoporous nano zeolite. In some embodiments, the method includes combining zeolite precursor materials, wherein the zeolite precursor materials comprise an aluminum source, a silica source, a template source, and a surfactant; stirring the zeolite precursor materials in the same reaction vessel to form a zeolite precursor mixture; drying the zeolite precursor mixture to form a dried zeolite powder; heating the dried zeolite powder in an autoclave to form a crystallized zeolite; and calcinating the crystallized zeolite to form a mesoporous nano zeolite.

The disclosed methods utilize a one-pot method of synthesizing mesoporous nano zeolite from starting materials. The disclosed methods combine the steps of synthesizing dry gel zeolite and then post-modification steps to form mesoporous nano zeolite. Utilization of a one-pot method may provide several advantages over synthetic methodologies performing the transformation in two separate steps, including: higher product yields, higher product purities, shorter reaction times, lower energy costs, use of less starting materials and solvents, and the formation of mesoporous nano zeolite with larger pore volume, larger average pore size, higher surface area, and smaller particle sizes.

The disclosed methods may result in mesoporous nano beta zeolite with lower crystal size compared to conventional methods of preparing mesoporous zeolites. The disclosed methods may result in mesoporous nano beta zeolite with larger pore volume compared to conventional methods of preparing mesoporous zeolites. The disclosed methods may result in mesoporous nano beta zeolite with larger average pore size compared to conventional methods of preparing mesoporous zeolites. The disclosed methods may result in mesoporous nano beta zeolite with higher surface area compared to conventional methods of preparing mesoporous zeolites. The disclosed methods may result in mesoporous nano beta zeolite with smaller particle sizes compared to conventional methods of preparing mesoporous zeolites. The disclosed methods may result in mesoporous nano beta zeolite with superior catalytic activity and stability compared to conventional methods of preparing mesoporous zeolites.

In this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

The term “about” as used herein can allow for a degree of variability in a value or range, for example, within ±10% of a stated value or of a stated limit of a range.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In the methods described in the present disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

In some embodiments, the method further comprises grinding the dried zeolite powder.

In some embodiments, the method further comprises washing the crystallized zeolite with a solvent.

In some embodiments, the method further comprises drying the crystallized zeolite after washing the crystallized zeolite.

The present disclosure further relates to methods of preparing a mesoporous nano zeolite comprising: combining zeolite precursor materials, wherein the zeolite precursor materials comprise an aluminum source, a silica source, a template source, and a surfactant; stirring the zeolite precursor materials in the same reaction vessel to form a zeolite precursor mixture; drying the zeolite precursor mixture to form a dried zeolite powder; grinding the dried zeolite powder; heating the dried zeolite powder in an autoclave to form a crystallized zeolite; washing the crystallized zeolite with a solvent; drying the crystallized zeolite; and calcinating the crystallized zeolite to form a mesoporous nano zeolite.

The present disclosure further relates to methods of preparing a mesoporous nano zeolite comprising: combining zeolite precursor materials, wherein the zeolite precursor materials comprise an aluminum source, a silica source, and a template source; adding a surfactant to the zeolite precursor materials; stirring the zeolite precursor materials in the same reaction vessel to form a zeolite precursor mixture; drying the zeolite precursor mixture to form a dried zeolite powder; grinding the dried zeolite powder; heating the dried zeolite powder in an autoclave to form a crystallized zeolite; washing the crystallized zeolite with a solvent; drying the crystallized zeolite; and calcinating the crystallized zeolite to form a mesoporous nano zeolite.

In some embodiments, the surfactant is added to the zeolite precursor materials before heating the dried zeolite powder in an autoclave.

In some embodiments, the aluminum source is selected from NaAlO₂, aluminum isopropoxide (AIP), Al₂(SO₄)₃, Al(NO₃)₃, AlCl₃, metal aluminum, and Al₂O₃.

In some embodiments, the aluminum source is NaAlO₂. In some embodiments, the aluminum source is aluminum isopropoxide (AIP). In some embodiments, the aluminum source is Al₂(SO₄)₃. In some embodiments, the aluminum source is Al(NO₃)₃. In some embodiments, the aluminum source is AlCl₃. In some embodiments, the aluminum source is metal aluminum. In some embodiments, the aluminum source is Al₂O₃.

In some embodiments, the silica source is selected from tetraethylorthosilicate (TEOS), colloidal silica, Na₂SiO₃, and fumed silica.

In some embodiments, the silica source is tetraethylorthosilicate (TEOS). In some embodiments, the silica source is colloidal silica. In some embodiments, the silica source is Na₂SiO₃. In some embodiments, the silica source is fumed silica.

In some embodiments, the template source is selected from tetrapropylammonium hydroxide (TPAOH) and tetraethylammonium hydroxide (TEAOH).

In some embodiments, the template source is tetrapropylammonium hydroxide (TPAOH). In some embodiments, the template source is tetraethylammonium hydroxide (TEAOH).

In some embodiments, the surfactant is selected from cetyltrimethylammonium bromide (CTAB) and cetrimonium chloride (CTAC).

In some embodiments, the surfactant is cetrimonium chloride (CTAC). In some embodiments, the surfactant is cetyltrimethylammonium bromide (CTAB).

In some embodiments, the aluminum source is selected from NaAlO₂, aluminum isopropoxide (AIP), Al₂(SO₄)₃, Al(NO₃)₃, AlCl₃, metal aluminum, and Al₂O₃; the silica source is selected from tetraethylorthosilicate (TEOS), colloidal silica, Na₂SiO₃, and fumed silica; the template source is selected from tetrapropylammonium hydroxide (TPAOH) and tetraethylammonium hydroxide (TEAOH); and the surfactant is selected from cetyltrimethylammonium bromide (CTAB) and cetrimonium chloride (CTAC).

In some embodiments, the aluminum source is NaAlO₂; the silica source is fumed silica; the template source is tetraethylammonium hydroxide (TEAOH); and the surfactant is cetyltrimethylammonium bromide (CTAB).

In some embodiments, combining the zeolite precursor materials comprises: preparing an aluminum solution; preparing a silica slurry; combining the aluminum solution and the silica slurry to form an aluminum-silica mixture; stirring the aluminum-silica mixture; and adding a surfactant to the aluminum-silica mixture to form an aluminum-silica-surfactant mixture.

In some embodiments, the aluminum solution comprises an aluminum source, a template source, and an aluminum solution solvent.

In some embodiments, the aluminum solution is stirred before combining the aluminum solution and the silica slurry to form an aluminum-silica mixture.

In some embodiments, the aluminum solution is stirred at room temperature for about 1 min to about 12 h before combining the aluminum solution and the silica slurry to form an aluminum-silica mixture.

In some embodiments, the aluminum solution is stirred at room temperature for about 1 min to about 12 h and then heated to about 30° C. to about 100° C. for about 0.5 h to about 24 h before combining the aluminum solution and the silica slurry to form an aluminum-silica mixture.

In some embodiments, the aluminum solution is stirred at room temperature for about 1 min to about 1 h and then heated to about 80° C. for about 1 h to about 6 h before combining the aluminum solution and the silica slurry to form an aluminum-silica mixture.

In some embodiments, the aluminum solution solvent is water.

In some embodiments, the silica slurry comprises a silica source, a template source, and a silica slurry solvent.

In some embodiments, the silica slurry solvent is water.

In some embodiments, the molar ratio of the template source to the silica source in the silica slurry is about 0.1 to about 0.8. In some embodiments, the molar ratio of the template source to the silica source in the silica slurry is about 0.2 to about 0.6.

In some embodiments, the molar ratio of the template source in the aluminum solution to the template source in the silica slurry is about 1 to about 5. In some embodiments, the molar ratio of the template source in the aluminum solution to the template source in the silica slurry is about 1.5 to about 4.

In some embodiments, the weight ratio of the surfactant to the total weight of the aluminum source and silica source is about 0.1 to about 3. In some embodiments, the weight ratio of the surfactant to the total weight of the aluminum source and silica source is about 0.2 to about 2.

In some embodiments, the aluminum-silica-surfactant mixture is stirred at room temperature for about 1 h to about 6 h.

In some embodiments, the zeolite precursor materials are stirred for about 0.5 h to about 24 h to form a zeolite precursor mixture. In some embodiments, the zeolite precursor materials are stirred for about 1 h to about 6 h to form a zeolite precursor mixture.

In some embodiments, the zeolite precursor materials are stirred for about 2 h to form a zeolite precursor mixture.

In some embodiments, the zeolite precursor mixture is dried at about 30° C. to about 100° C. for about 1 h to about 60 h to form a dried zeolite powder. In some embodiments, the zeolite precursor mixture is dried at about 40° C. to about 90° C. for about 8 h to about 48 h to form a dried zeolite powder.

In some embodiments, the zeolite precursor mixture is dried at about 80° C. for about 8 h to about 48 h to form a dried zeolite powder.

In some embodiments, the dried zeolite powder is heated in an autoclave at about 80° C. to about 230° C. for about 12 h to about 120 h to form a crystallized zeolite. In some embodiments, the dried zeolite powder is heated in an autoclave at about 110° C. to about 200° C. for about 24 h to about 96 h to form a crystallized zeolite.

In some embodiments, the dried zeolite powder is heated in an autoclave at about 140° C. for about 48 h to form a crystallized zeolite.

In some embodiments, the crystallized zeolite is washed with a solvent, wherein the solvent is water.

In some embodiments, the crystallized zeolite is dried at about 50° C. to about 250° C. for about 1 h to about 48 h. In some embodiments, the crystallized zeolite is dried at about 100° C. to about 200° C. for about 4 h to about 24 h.

In some embodiments, the crystallized zeolite is dried at about 110° C. for about 16 h.

In some embodiments, the crystallized zeolite is calcinated at about 450° C. to about 700° C. for 0.5 h to 12 h with a ramp rate of about 0.5° C. to about 10° C. per minute. In some embodiments, the crystallized zeolite is calcinated at about 500° C. to about 650° C. for 1 h to 6 h with a ramp rate of about 1° C. to about 5° C. per minute.

In some embodiments, the crystallized zeolite is calcinated at about 550° C. for 4 h with a ramp rate of about 2° C. per minute.

In some embodiments, the mesoporous nano zeolite is mesoporous nano beta zeolite.

In some embodiments, the mesoporous nano zeolite has an average particle size of about 10 nm to about 80 nm. In some embodiments, the mesoporous nano zeolite has an average particle size of about 40 nm to about 60 nm. In some embodiments, the mesoporous nano zeolite has an average particle size of about 45 nm to about 55 nm.

In some embodiments, the mesoporous nano zeolite has an average particle size of about 10 nm. In some embodiments, the mesoporous nano zeolite has an average particle size of about 20 nm. In some embodiments, the mesoporous nano zeolite has an average particle size of about 30 nm. In some embodiments, the mesoporous nano zeolite has an average particle size of about 40 nm. In some embodiments, the mesoporous nano zeolite has an average particle size of about 45 nm. In some embodiments, the mesoporous nano zeolite has an average particle size of about 50 nm. In some embodiments, the mesoporous nano zeolite has an average particle size of about 55 nm. In some embodiments, the mesoporous nano zeolite has an average particle size of about 60 nm. In some embodiments, the mesoporous nano zeolite has an average particle size of about 70 nm. In some embodiments, the mesoporous nano zeolite has an average particle size of about 80 nm.

In some embodiments, the mesoporous nano zeolite is formed in a yield of about 50% to about 100%. In some embodiments, the mesoporous nano zeolite is formed in a yield of about 70% to about 100%. In some embodiments, the mesoporous nano zeolite is formed in a yield of about 90% to about 100%.

In some embodiments, the mesoporous nano zeolite is formed in a yield of about 50%. In some embodiments, the mesoporous nano zeolite is formed in a yield of about 60%. In some embodiments, the mesoporous nano zeolite is formed in a yield of about 70%. In some embodiments, the mesoporous nano zeolite is formed in a yield of about 75%. In some embodiments, the mesoporous nano zeolite is formed in a yield of about 80%. In some embodiments, the mesoporous nano zeolite is formed in a yield of about 85%. In some embodiments, the mesoporous nano zeolite is formed in a yield of about 90%. In some embodiments, the mesoporous nano zeolite is formed in a yield of about 95%. In some embodiments, the mesoporous nano zeolite is formed in a yield of about 100%.

In some embodiments, the mesoporous nano zeolite has an average surface area of about 500 m²/g to about 700 m²/g. In some embodiments, the mesoporous nano zeolite has an average surface area of about 600 m²/g to about 700 m²/g. In some embodiments, the mesoporous nano zeolite has an average surface area of about 650 m²/g to about 700 m²/g.

In some embodiments, the mesoporous nano zeolite has an average surface area of about 500 m²/g. In some embodiments, the mesoporous nano zeolite has an average surface area of about 550 m²/g. In some embodiments, the mesoporous nano zeolite has an average surface area of about 600 m²/g. In some embodiments, the mesoporous nano zeolite has an average surface area of about 650 m²/g. In some embodiments, the mesoporous nano zeolite has an average surface area of about 675 m²/g. In some embodiments, the mesoporous nano zeolite has an average surface area of about 700 m²/g. In some embodiments, the mesoporous nano zeolite has an average surface area of about 750 m²/g.

In some embodiments, the mesoporous nano zeolite has an average pore volume of about 1.0 mL/g to about 1.8 mL/g. In some embodiments, the mesoporous nano zeolite has an average pore volume of about 1.1 mL/g to about 1.7 mL/g. In some embodiments, the mesoporous nano zeolite has an average pore volume of about 1.3 mL/g to about 1.5 mL/g.

In some embodiments, the mesoporous nano zeolite has an average pore volume of about 1.0 mL/g. In some embodiments, the mesoporous nano zeolite has an average pore volume of about 1.1 mL/g. In some embodiments, the mesoporous nano zeolite has an average pore volume of about 1.3 mL/g. In some embodiments, the mesoporous nano zeolite has an average pore volume of about 1.4 mL/g. In some embodiments, the mesoporous nano zeolite has an average pore volume of about 1.5 mL/g. In some embodiments, the mesoporous nano zeolite has an average pore volume of about 1.6 mL/g. In some embodiments, the mesoporous nano zeolite has an average pore volume of about 1.7 mL/g. In some embodiments, the mesoporous nano zeolite has an average pore volume of about 1.8 mL/g.

In some embodiments, the mesoporous nano zeolite has an average pore size of about 6.0 nm to about 10.0 nm. In some embodiments, the mesoporous nano zeolite has an average pore size of about 7.1 nm to about 9.5 nm. In some embodiments, the mesoporous nano zeolite has an average pore size of about 7.8 nm to about 8.8 nm.

In some embodiments, the mesoporous nano zeolite has an average pore size of about 6.0 nm. In some embodiments, the mesoporous nano zeolite has an average pore size of about 6.5 nm. In some embodiments, the mesoporous nano zeolite has an average pore size of about 7.1 nm. In some embodiments, the mesoporous nano zeolite has an average pore size of about 7.8 nm. In some embodiments, the mesoporous nano zeolite has an average pore size of about 8.3 nm. In some embodiments, the mesoporous nano zeolite has an average pore size of about 8.8 nm. In some embodiments, the mesoporous nano zeolite has an average pore size of about 10.0 nm.

In some embodiments, the mesoporous nano zeolite has a relative crystallinity of about 60% to about 100%. In some embodiments, the mesoporous nano zeolite has a relative crystallinity of about 80% to about 100%. In some embodiments, the mesoporous nano zeolite has a relative crystallinity of about 90% to about 100%. In some embodiments, the mesoporous nano zeolite has a relative crystallinity of about 95% to about 100%.

In some embodiments, the mesoporous nano zeolite has a relative crystallinity of about 60%. In some embodiments, the mesoporous nano zeolite has a relative crystallinity of about 65%. In some embodiments, the mesoporous nano zeolite has a relative crystallinity of about 70%. In some embodiments, the mesoporous nano zeolite has a relative crystallinity of about 75%. In some embodiments, the mesoporous nano zeolite has a relative crystallinity of about 80%. In some embodiments, the mesoporous nano zeolite has a relative crystallinity of about 85%. In some embodiments, the mesoporous nano zeolite has a relative crystallinity of about 90%. In some embodiments, the mesoporous nano zeolite has a relative crystallinity of about 95%. In some embodiments, the mesoporous nano zeolite has a relative crystallinity of about 100%.

### EXAMPLES

### Example 1. Comparison of One-Pot Method of Preparing Mesoporous Nano Beta Zeolite with Conventional Methods

Mesoporous nano beta zeolite was prepared using a conventional two-step process (Ref-1 and Ref-2) and compared to the mesoporous nano beta zeolite product prepared using the disclosed one-pot method (A). The results, including product yield and zeolite properties, are summarized below in Table 1.

### Method Ref-1: Preparation of Dry Gel Zeolite Using Hydrogel Method

1. A precursor solution comprising TEAOH, SiO₂, Al₂O₃, and water in a molar composition ratio of 30:50:1:750 was prepared.
2. Metal aluminum powder (0.27 g) was dissolved in a solution of TEAOH (25 g, 35% aq.) and stirred at room temperature for 1 h to form a clear solution.
3. Fumed silica (15 g) and a solution of TEAOH (38 g, 35% aq.) were added to the aluminum solution.
4. The resulting mixture was stirred at room temperature for 4 h.
5. The resulting mixture was transferred to an autoclave and heated to 140° C. for 3 days to form a solid product.
6. An aqueous solution of ammonia (50 g, 1.0 M) was added to the solid product and the resulting mixture was stirred at room temperature for 2 h.
7. The mixture was heated in an oven at 100° C. for 10 h.
8. The product was filtrated, washed with deionized water ten times, dried at 120° C. for 10 h.
9. The product was calcinated at 600° C. for 4 h to prepare nano beta zeolite.
   Method Ref-2: Preparation of Mesoporous Nano Beta Zeolite with Post Synthesis Modification
1. NaOH (0.1 g) and an aqueous solution of ammonia (62.5 g, 0.5 M) were combined in a beaker and stirred for 2 min.
2. Nano beta zeolite (4.56 g) and CTAB (1.13 g) were added to the ammonia solution, and stirred at room temperature for 30 min.
3. The resulting mixture was transferred into a PTFE lined autoclave and heated to 100° C. for 10 h.
4. The formed colloid was washed with distilled water several times.
5. The colloidal suspension was centrifuged at 12,000 rpm to obtain a solid product.
6. The solid product was dried in an oven at 110° C. overnight.
7. The dried solid was calcinated at 550° C. for 4 h with a ramp rate of 2° C./min to form mesoporous nano beta zeolite.

### Method A: One-Pot Synthesis of Mesoporous Nano Beta Zeolite

1. A solution of TEAOH (10.25 g, 35% aq.) and sodium aluminate (0.41 g) were combined in a beaker. The mixture was stirred at room temperature until all of the solid was dissolved and a clear solution was formed.
2. A solution of TEAOH (5.53, 35% aq.), fumed silica (3.75 g) and purified water (6.62 g) were combined in a second beaker.
3. The sodium aluminate and silica solutions from (1) and (2) were combined and stirred at room temperature for 2 h.
4. CTAB (1.5 g) was added to the combined solution, and the resulting mixture was stirred at room temperature for an additional 2 h.
5. The mixture was transferred to a flask dried in an oven at 80° C. until the mixture dried into a solid.
6. The solid was ground into a powder and placed into a sample holder.
7. The sample holder was added to an autoclave with water (10 mL), sealed, and heated to 140° C. for two days.
8. The solid product was washed two times.
9. The solid was dried in an oven at 110° C. overnight.
10. The solid was calcinated at 550° C. for 4 h at 2° C./min to form mesoporous nano beta zeolite.

TABLE 1
Summary of the yield and properties of the zeolites
prepared by Methods Ref-1, Ref-2, and A.

| Method | Ref-1 | Ref-2 | A |
|---|---|---|---|
| Product | nano beta | mesoporous | mesoporous |
| | zeolite | nano beta | nano beta |
| | | zeolite | zeolite |
| Product Yield | 60% | 65% | 96% |
| Particle Size (nm) | 60 | 60 | 50 |
| Surface Area (m²/g) | 672 | 626 | 678 |
| Pore Volume (mL/g) | 1.3 | 1.1 | 1.4 |
| Average Pore Size (nm) | 7.7 | 7.0 | 8.3 |
| Crystallinity | 100% | 97% | 99% |

As shown in Table 1, the mesoporous nano beta zeolite obtained using the disclosed method (A) was formed in higher yield than the product of the comparative method, Ref-2. The mesoporous nano beta zeolite obtained using the disclosed method (A) exhibited smaller particle sizes, higher surface areas, larger pore volumes, higher average pore sizes, and comparable crystallinity as compared to the mesoporous nano beta zeolite obtained comparative method mesoporous nano beta zeolite obtained using the disclosed method Ref-2.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

### EMBODIMENTS

Embodiment 1. A method of preparing a mesoporous nano zeolite comprising:
combining zeolite precursor materials, wherein the zeolite precursor materials comprise an aluminum source, a silica source, a template source, and a surfactant;
stirring the zeolite precursor materials in the same reaction vessel to form a zeolite precursor mixture;
drying the zeolite precursor mixture to form a dried zeolite powder;
heating the dried zeolite powder in an autoclave to form a crystallized zeolite; and
calcinating the crystallized zeolite to form a mesoporous nano zeolite.

Embodiment 2. The method of embodiment 1, wherein the method further comprises:
grinding the dried zeolite powder.

Embodiment 3. The method of embodiment 1 or 2, wherein the method further comprises:
washing the crystallized zeolite with a solvent.

Embodiment 4. The method of embodiment 3, wherein the method further comprises:
drying the crystallized zeolite after washing the crystallized zeolite.

Embodiment 5. A method of preparing a mesoporous nano zeolite comprising:
combining zeolite precursor materials, wherein the zeolite precursor materials comprise an aluminum source, a silica source, a template source, and a surfactant;
stirring the zeolite precursor materials in the same reaction vessel to form a zeolite precursor mixture;
drying the zeolite precursor mixture to form a dried zeolite powder;
grinding the dried zeolite powder;
heating the dried zeolite powder in an autoclave to form a crystallized zeolite;
washing the crystallized zeolite with a solvent;
drying the crystallized zeolite; and
calcinating the crystallized zeolite to form a mesoporous nano zeolite.

Embodiment 6. The method of any one of embodiments 1-5, wherein the aluminum source is selected from NaAlO₂, aluminum isopropoxide (AIP), Al₂(SO₄)₃, Al(NO₃)₃, AlCl₃, metal aluminum, and Al₂O₃.

Embodiment 7. The method of embodiment 6, wherein the aluminum source is NaAlO₂.

Embodiment 8. The method of any one of embodiments 1-7, wherein the silica source is selected from tetraethylorthosilicate (TEOS), colloidal silica, Na₂SiO₃, and fumed silica.

Embodiment 9. The method of embodiment 8, wherein the silica source is fumed silica.

Embodiment 10. The method of any one of embodiments 1-9, wherein the template source is selected from tetrapropylammonium hydroxide (TPAOH) and tetraethylammonium hydroxide (TEAOH).

Embodiment 11. The method of embodiment 10, wherein the template source is tetraethylammonium hydroxide (TEAOH).

Embodiment 12. The method of any one of embodiments 1-11, wherein the surfactant is selected from cetyltrimethylammonium bromide (CTAB) and cetrimonium chloride (CTAC).

Embodiment 13. The method of embodiment 12, wherein the surfactant is cetyltrimethylammonium bromide (CTAB).

Embodiment 14. The method of any one of embodiments 1-5, wherein:
the aluminum source is selected from NaAlO₂, aluminum isopropoxide (AIP), Al₂(SO₄)₃, Al(NO₃)₃, AlCl₃, metal aluminum, and Al₂O₃;
the silica source is selected from tetraethylorthosilicate (TEOS), colloidal silica, Na₂SiO₃, and fumed silica;
the template source is selected from tetrapropylammonium hydroxide (TPAOH) and tetraethylammonium hydroxide (TEAOH); and
the surfactant is selected from cetyltrimethylammonium bromide (CTAB) and cetrimonium chloride (CTAC).

Embodiment 15. The method of embodiment 14, wherein:
the aluminum source is NaAlO₂;
the silica source is fumed silica;
the template source is tetraethylammonium hydroxide (TEAOH); and
the surfactant is cetyltrimethylammonium bromide (CTAB).

Embodiment 16. The method of any one of embodiments 1-15, wherein combining the zeolite precursor materials comprises:
preparing an aluminum solution;
preparing a silica slurry;
combining the aluminum solution and the silica slurry to form an aluminum-silica mixture;
stirring the aluminum-silica mixture; and
adding a surfactant to the aluminum-silica mixture to form an aluminum-silica-surfactant mixture.

Embodiment 17. The method of embodiment 16, wherein the aluminum solution comprises an aluminum source, a template source, and an aluminum solution solvent.

Embodiment 18. The method of embodiment 16 or 17, wherein aluminum solution is stirred before combining the aluminum solution and the silica slurry to form an aluminum-silica mixture.

Embodiment 19. The method of embodiment 18, wherein the aluminum solution is stirred at room temperature for about 1 min to about 12 h before combining the aluminum solution and the silica slurry to form an aluminum-silica mixture.

Embodiment 20. The method of embodiment 18, wherein the aluminum solution is stirred at room temperature for about 1 min to about 12 h and then heated to about 30° C. to about 100° C. for about 0.5 h to about 24 h before combining the aluminum solution and the silica slurry to form an aluminum-silica mixture.

Embodiment 21. The method of embodiment 18, wherein the aluminum solution is stirred at room temperature for about 1 min to about 1 h and then heated to about 80° C. for about 1 h to about 6 h before combining the aluminum solution and the silica slurry to form an aluminum-silica mixture.

Embodiment 22. The method of any one of embodiments 18-21, wherein the aluminum solution solvent is water.

Embodiment 23. The method of any one of embodiments 18-22, wherein the silica slurry comprises a silica source, a template source, and a silica slurry solvent.

Embodiment 24. The method of embodiment 23, wherein the silica slurry solvent is water.

Embodiment 25. The method of any one of embodiments 16-24, wherein the molar ratio of the template source to the silica source in the silica slurry is about 0.2 to about 0.6.

Embodiment 26. The method of any one of embodiments 16-24, wherein the molar ratio of the template source in the aluminum solution to the template source in the silica slurry is about 1.5 to about 4.

Embodiment 27. The method of any one of embodiments 16-26, wherein the weight ratio of the surfactant to the total weight of the aluminum source and silica source is about 0.2 to about 2.

Embodiment 28. The method of any one of embodiments 18-27, wherein the aluminum-silica-surfactant mixture is stirred at room temperature for about 1 h to about 6 h.

Embodiment 29. The method of any one of embodiments 1-28, wherein the zeolite precursor materials are stirred for about 0.5 h to about 24 h to form a zeolite precursor mixture.

Embodiment 30. The method of any one of embodiments 1-28, wherein the zeolite precursor materials are stirred for about 1 h to about 6 h to form a zeolite precursor mixture.

Embodiment 31. The method of any one of embodiments 1-28, wherein the zeolite precursor materials are stirred for about 2 h to form a zeolite precursor mixture.

Embodiment 32. The method of any one of embodiments 1-31, wherein the zeolite precursor mixture is dried at about 30° C. to about 100° C. for about 1 h to about 60 h to form a dried zeolite powder.

Embodiment 33. The method of any one of embodiments 1-31, wherein the zeolite precursor mixture is dried at about 40° C. to about 90° C. for about 8 h to about 48 h to form a dried zeolite powder.

Embodiment 34. The method of any one of embodiments 1-31, wherein the zeolite precursor mixture is dried at about 80° C. for about 8 h to about 48 h to form a dried zeolite powder.

Embodiment 35. The method of any one of embodiments 1-34, wherein the dried zeolite powder is heated in an autoclave at about 80° C. to about 230° C. for about 12 h to about 120 h to form a crystallized zeolite.

Embodiment 36. The method of any one of embodiments 1-34, wherein the dried zeolite powder is heated in an autoclave at about 110° C. to about 200° C. for about 24 h to about 96 h to form a crystallized zeolite.

Embodiment 37. The method of any one of embodiments 1-34, wherein the dried zeolite powder is heated in an autoclave at about 140° C. for about 48 h to form a crystallized zeolite.

Embodiment 38. The method of any one of embodiments 5-37, wherein the crystallized zeolite is washed with a solvent, wherein the solvent is water.

Embodiment 39. The method of any one of embodiments 5-38, wherein the crystallized zeolite is dried at about 50° C. to about 250° C. for about 1 h to about 48 h.

Embodiment 40. The method of any one of embodiments 5-38, wherein the crystallized zeolite is dried at about 100° C. to about 200° C. for about 4 h to about 24 h.

Embodiment 41. The method of any one of embodiments 5-38, wherein the crystallized zeolite is dried at about 110° C. for about 16 h.

Embodiment 42. The method of any one of embodiments 1-41, wherein the crystallized zeolite is calcinated at about 450° C. to about 700° C. for 0.5 h to 12 h with a ramp rate of about 0.5° C. to about 10° C. per minute.

Embodiment 43. The method of any one of embodiments 1-41, wherein the crystallized zeolite is calcinated at about 500° C. to about 650° C. for 1 h to 6 h with a ramp rate of about 1° C. to about 5° C. per minute.

Embodiment 44. The method of any one of embodiments 1-41, wherein the crystallized zeolite is calcinated at about 550° C. for 4 h with a ramp rate of about 2° C. per minute.

Embodiment 45. The method of any one of embodiments 1-44, wherein the mesoporous nano zeolite is mesoporous nano beta zeolite.

Embodiment 46. The method of any one of embodiments 1-45, wherein the mesoporous nano zeolite has an average particle size of about 10 nm to about 80 nm.

Embodiment 47. The method of any one of embodiments 1-45, wherein the mesoporous nano zeolite has an average particle size of about 40 nm to about 60 nm.

Embodiment 48. The method of any one of embodiments 1-45, wherein the mesoporous nano zeolite has an average particle size of about 45 nm to about 55 nm.

Embodiment 49. The method of any one of embodiments 1-45, wherein the mesoporous nano zeolite has an average particle size of about 50 nm.

Embodiment 50. The method of any one of embodiments 1-49, wherein the mesoporous nano zeolite is formed in a yield of about 50% to about 100%.

Embodiment 51. The method of any one of embodiments 1-49, wherein the mesoporous nano zeolite is formed in a yield of about 70% to about 100%.

Embodiment 52. The method of any one of embodiments 1-49, wherein the mesoporous nano zeolite is formed in a yield of about 90% to about 100%.

Embodiment 53. The method of any one of embodiments 1-52, wherein the mesoporous nano zeolite has an average surface area of about 500 m²/g to about 700 m²/g.

Embodiment 54. The method of any one of embodiments 1-52, wherein the mesoporous nano zeolite has an average surface area of about 600 m²/g to about 700 m²/g.

Embodiment 55. The method of any one of embodiments 1-52, wherein the mesoporous nano zeolite has an average surface area of about 650 m²/g to about 700 m²/g.

Embodiment 56. The method of any one of embodiments 1-55, wherein the mesoporous nano zeolite has an average pore volume of about 1.0 mL/g to about 1.8 mL/g.

Embodiment 57. The method of any one of embodiments 1-55, wherein the mesoporous nano zeolite has an average pore volume of about 1.1 mL/g to about 1.7 mL/g.

Embodiment 58. The method of any one of embodiments 1-55, wherein the mesoporous nano zeolite has an average pore volume of about 1.3 mL/g to about 1.5 mL/g.

Embodiment 59. The method of any one of embodiments 1-55, wherein the mesoporous nano zeolite has an average pore volume of about 1.4 mL/g.

Embodiment 60. The method of any one of embodiments 1-59, wherein the mesoporous nano zeolite has an average pore size of about 7.1 nm to about 9.5 nm.

Embodiment 61. The method of any one of embodiments 1-59, wherein the mesoporous nano zeolite has an average pore size of about 7.8 nm to about 8.8 nm.

Embodiment 62. The method of any one of embodiments 1-59, wherein the mesoporous nano zeolite has an average pore size of about 8.3 nm.

Embodiment 63. The method of any one of embodiments 1-62, wherein the mesoporous nano zeolite has a relative crystallinity of about 60% to about 100%.

Embodiment 64. The method of any one of embodiments 1-62, wherein the mesoporous nano zeolite has a relative crystallinity of about 80% to about 100%.

Embodiment 65. The method of any one of embodiments 1-62, wherein the mesoporous nano zeolite has a relative crystallinity of about 90% to about 100%.

What is claimed is:

1. A method of preparing a mesoporous nano zeolite comprising:
combining zeolite precursor materials in a reaction vessel, wherein the zeolite precursor materials comprise an aluminum source, a silica source, a template source, and a surfactant;
stirring the zeolite precursor materials in the same reaction vessel to form a zeolite precursor mixture;
drying the zeolite precursor mixture to form a dried zeolite powder;
heating the dried zeolite powder in an autoclave to form a crystallized zeolite; and
calcinating the crystallized zeolite to form a mesoporous nano zeolite.

2. The method of claim 1, wherein the method further comprises:
grinding the dried zeolite powder.

3. The method of claim 1, wherein the method further comprises:
washing the crystallized zeolite with a solvent.

4. The method of claim 3, wherein the method further comprises:
drying the crystallized zeolite after washing the crystallized zeolite.

5. The method of claim 1, wherein the aluminum source is selected from NaAlO₂, aluminum isopropoxide (AIP), Al₂(SO₄)₃, Al(NO₃)₃, AlCl₃, metal aluminum, and Al₂O₃.

6. The method of claim 1, wherein the silica source is selected from tetraethylorthosilicate (TEOS), colloidal silica, Na₂SiO₃, and fumed silica.

7. The method of claim 1, wherein the template source is selected from tetrapropylammonium hydroxide (TPAOH) and tetraethylammonium hydroxide (TEAOH).

8. The method of claim 1, wherein the surfactant is selected from cetyltrimethylammonium bromide (CTAB) and cetrimonium chloride (CTAC).

9. The method of claim 1, wherein:
the aluminum source is selected from NaAlO₂, aluminum isopropoxide (AIP), Al₂(SO₄)₃, Al(NO₃)₃, AlCl₃, metal aluminum, and Al₂O₃;
the silica source is selected from tetraethylorthosilicate (TEOS), colloidal silica, Na₂SiO₃, and fumed silica;
the template source is selected from tetrapropylammonium hydroxide (TPAOH) and tetraethylammonium hydroxide (TEAOH); and
the surfactant is selected from cetyltrimethylammonium bromide (CTAB) and cetrimonium chloride (CTAC).

10. The method of claim 1, wherein:
the aluminum source is NaAlO₂;
the silica source is fumed silica;
the template source is tetraethylammonium hydroxide (TEAOH); and
the surfactant is cetyltrimethylammonium bromide (CTAB).

11. The method of claim 1, wherein the mesoporous nano zeolite is mesoporous nano beta zeolite.

12. The method of claim 1, wherein the mesoporous nano zeolite has an average particle size of about 45 nm to about 55 nm.

13. The method of claim 1, wherein the mesoporous nano zeolite is formed in a yield of about 90% to about 100%.

14. The method of claim 1, wherein the mesoporous nano zeolite has an average pore volume of about 1.0 mL/g to about 1.8 mL/g.

15. The method of claim 1, wherein the mesoporous nano zeolite has an average pore volume of about 1.1 mL/g to about 1.7 mL/g.

16. The method of claim 1, wherein the mesoporous nano zeolite has an average pore size of about 7.8 nm to about 8.8 nm.

17. The method of claim 1, wherein the mesoporous nano zeolite has a relative crystallinity of about 90% to about 100%.

18. A method of preparing a mesoporous nano zeolite comprising:
combining zeolite precursor materials in a reaction vessel, wherein the zeolite precursor materials comprise an aluminum source, a silica source, a template source, and a surfactant;
stirring the zeolite precursor materials in the same reaction vessel to form a zeolite precursor mixture;
drying the zeolite precursor mixture to form a dried zeolite powder;
grinding the dried zeolite powder;
heating the dried zeolite powder in an autoclave to form a crystallized zeolite;
washing the crystallized zeolite with a solvent;
drying the crystallized zeolite; and
calcinating the crystallized zeolite to form a mesoporous nano zeolite.

19. The method of claim 18, wherein:
the aluminum source is selected from NaAlO₂, aluminum isopropoxide (AIP), Al₂(SO₄)₃, Al(NO₃)₃, AlCl₃, metal aluminum, and Al₂O₃;
the silica source is selected from tetraethylorthosilicate (TEOS), colloidal silica, Na₂SiO₃, and fumed silica;
the template source is selected from tetrapropylammonium hydroxide (TPAOH) and tetraethylammonium hydroxide (TEAOH); and
the surfactant is selected from cetyltrimethylammonium bromide (CTAB) and cetrimonium chloride (CTAC).

20. The method of claim 18, wherein the mesoporous nano zeolite has an average pore volume of about 1.1 mL/g to about 1.7 mL/g.
